(19) United States
(12) Patent Application Publication
(10) Pub. No.: US 2010/0187338 A1
(43) Pub. Date: Jul. 29, 2010

(54) ELECTROSTATICALLY ATOMIZING DEVICE

(76) Inventors: Takeshi Yano, Kyoto-shi (JP); Akihide Sugawa, Hikone-shi (JP)

Correspondence Address: Cheng Law Group, PLLC, 1100 17th Street, N.W., Suite 503, Washington, DC, 20036, US

(21) Appl. No.: 12/692,767

(22) Filed: Jan. 25, 2010

(30) Foreign Application Priority Data
Jan. 27, 2009 (JP) 2009-015949

(51) Int. Cl. B05B 5/00; B05B 5/057

(52) U.S. Cl. 239/690

(57) ABSTRACT

An electrostatically atomizing device comprises an emitter electrode, an opposed electrode, a water supply means, a high voltage source, and a silencer. The opposed electrode is disposed in an opposed relation to the emitter electrode. The water supply means is configured to supply water to the emitter electrode. The high voltage source is configured to apply voltage between the emitter electrode and the opposed electrode in order to electrostatically atomize the water on the emitter electrode, thereby generating a mist. The silencer includes a sound absorbing duct being formed into tubular shape to have an axial bore. The axial bore is formed at its one axial end with an inlet in communication with the opening, and is formed at the other axial end with an outlet for flowing the mist out through the axial bore. The sound absorbing duct is attached to the opposed electrode such that the inlet is kept in communication with the opening. The sound absorbing duct has an inner circumferential surface. The inner circumferential surface includes a sound absorbing surface. The sound absorbing surface is located between the opposed electrode and the outlet. Entire area of the sound absorbing surface is uncovered.

### TECHNICAL FIELD

This invention relates to an electrostatically atomizing device. The electrostatically atomizing device is configured to generate a mist of charged minute water particles, and supply the mist to a room. The electrostatically atomizing device causes noises when the electrostatically atomizing device generates the mist. Accordingly, the electrostatically atomizing device comprises a silencer which absorbs the noises.

### BACKGROUND ART

Japanese patent application publication No. 2005-131549A, hereinafter referred to as Patent application 1, discloses an electrostatically atomizing device. This electrostatically atomizing device comprises an emitter electrode, an opposed electrode with an opening, an atomizing barrel, a high voltage source, and a water supply means. The emitter electrode and the opposed electrode is supported to the atomizing barrel such that the opposed electrode is disposed in an opposed relation to the emitter electrode. The water supply means is configured to supply water to a tip of the emitter electrode. The high voltage source is configured to apply voltage between the emitter electrode and the opposed electrode. When the high voltage source applies the voltage between the emitter electrode and the opposed electrode, electrical field is generated between the emitter electrode and the opposed electrode. When the water on the tip of the emitter electrode is subjected to the electrical field, the water is formed to have a cone shape. This cone shaped water is so called Taylor cone. In addition, when the cone shaped water is subjected to the electrical field, the cone shaped water is electrostatically atomized, thereby generating a mist of the charged minute water particles of nanometer sizes. This mist of the charged minute water particles of nanometer sizes is discharged through the opening of the opposed electrode.

When the electrostatically atomizing device of Patent application 1 generates the mist of the charged minute water particles, noise generation is caused according to an electrostatically atomizing.

With respect to the problem of the electrostatically atomizing device of the Patent application 1, Japanese patent application publication No. 2007-289918, hereinafter referred to as Patent application 2, discloses an electrostatically atomizing device with a silencer duct. The silencer duct comprises a holder and a sound absorbing member. The holder is composed of an inside cylinder and an outside cylinder. The inside cylinder defines a mist flow path. The inside cylinder is formed with a plurality of slits. The outside cylinder is cooperative with the inside cylinder to form a space therebetween. The sound absorbing member is disposed in the space of the holder. Therefore, the sound absorbing member is exposed to the mist flow path through the slit. The silencer duct is attached to the atomizing barrel such that the opening of the opposed electrode communicates with the inside cylinder. The electrostatically atomizing device of the Patent application 2 also generates the mist of the charged minute water particles of nanometer sizes and the noises. The mist and the noises pass through the opening and an inside of the inside cylinder. The mist of the charged minute water particles of nanometer sizes is discharged from an outlet at one end of the silencer duct. On the other hand, the noises pass through the slit of the inside cylinder, and subsequently the noises are absorbed by the sound absorbing member. In this manner, the noises generated by the electrostatically atomization is reduced.

In the electrostatically atomizing device of the Patent application 2, most of the noises pass through the slit of the inside cylinder, thereby being absorbed by the sound absorbing member. However, the sound absorbing member is partially exposed to the air in the inside cylinder through the slit. Therefore, a part of the noises is reflected by the inside cylinder. Therefore, a part of the noises pass through the silencer duct. Furthermore, the silencer duct in the Patent application 2 is attached to the atomizing barrel such that one end of the inside cylinder is fitted into the one end of the atomizing barrel. Therefore, it is required to employ large silencer duct in order to ensure sufficient sound absorbing property of the silencer duct. That is, the electrostatically atomizing device with the silencer duct in the Patent application 2 has large dimension.

### DISCLOSURE OF THE INVENTION

This invention is achieved to solve the above problem. An object of this invention is to provide an electrostatically atomizing device having a silencer which is configured to absorb all noises which is generated when the electrostatically atomizing is performed.

In order to solve the above problem, this invention discloses an electrostatically atomizing device 100. This electrostatically atomizing device comprises an emitter electrode, an opposed electrode, a water supply means, and a silencer. The emitter electrode is formed into a rod shape. The opposed electrode has an opening. The opposed electrode is disposed in an opposed relation to the emitter electrode. The water supply means is configured to supply water to the emitter electrode. The high voltage source is configured to apply voltage between the emitter electrode and the opposed electrode in order to electrostatically atomize the water supplied to the emitter electrode, thereby generating a mist which flows through the opening. The silencer includes a sound absorbing duct. The sound absorbing duct is formed into tubular shape to have an axial bore. The axial bore is formed at its one axial end with an inlet in communication with the opening, and is formed at the other axial end with an outlet for flowing the mist out through the axial bore. The sound absorbing duct is attached to the opposed electrode such that the inlet is kept in communication with the opening for directing the mist out of the sound absorbing duct through the outlet. The inner circumferential surface includes a sound absorbing surface. The sound absorbing surface is located between said opposed electrode and said outlet. The sound absorbing surface extends the entire inner circumference of said inner circumferential surface. The entire circumference of the sound absorbing surface is uncovered.

When the water on the emitter electrode is electrostatically atomized, the noises are generated. However, with this configuration, the noises are absorbed by the sound absorbing duct.

It is preferred that the opposed electrode is shaped to have a cylinder 252. The cylinder is fitted into the inlet.

This configuration makes it possible to direct the mist toward the outlet through the sound absorbing duct. Furthermore, the silencer is directly attached to the opposed electrode having a cylindrical shape. Therefore, this configuration also makes it possible to reduce the dimension of the electrostatically atomizing device.

It is preferred that the axial bore has an inside diameter which gradually becomes smaller from the inlet toward the outlet.

With this configuration, the sound absorbing duct effectively absorbs the noises. Furthermore, this configuration makes it possible to prevent spreading of the mist. Therefore, the mist which is discharged from the outlet is applied to target. In addition, this configuration makes it possible to increase an amount of the sound absorbing duct. Therefore, the noises are effectively absorbed by this configuration.

It is preferred that the opposed electrode has a first end and a second end. The sound absorbing surface is located between the first end and the outlet.

It is preferred that the cylinder has a first end, and a second end. The sound absorbing surface is located between the first end and the outlet.

It is preferred that the water supply means is defined by a Peltier module 501. The Peltier module is configured to cool the emitter electrode. The emitter electrode is configured to cool the air around the emitter electrode such that the emitter electrode condenses the vapor in the air into the water on the emitter electrode.

### BRIEF EXPLANATION OF THE DRAWINGS

FIG. 1 is a side cross sectional view of the electrostatically atomizing device of a first embodiment.

FIG. 2 is a side cross sectional view of a housing which incorporates the electrostatically atomizing device.

FIG. 3 is an exploded perspective view of the housing and the electrostatically atomizing device.

FIG. 4 is an exploded perspective view of the electrostatically atomizing device.

FIG. 5 is a side cross sectional view of the electrostatically atomizing device of a second embodiment.

### BEST MODE FOR CARRYING OUT THE INVENTION

### First Embodiment

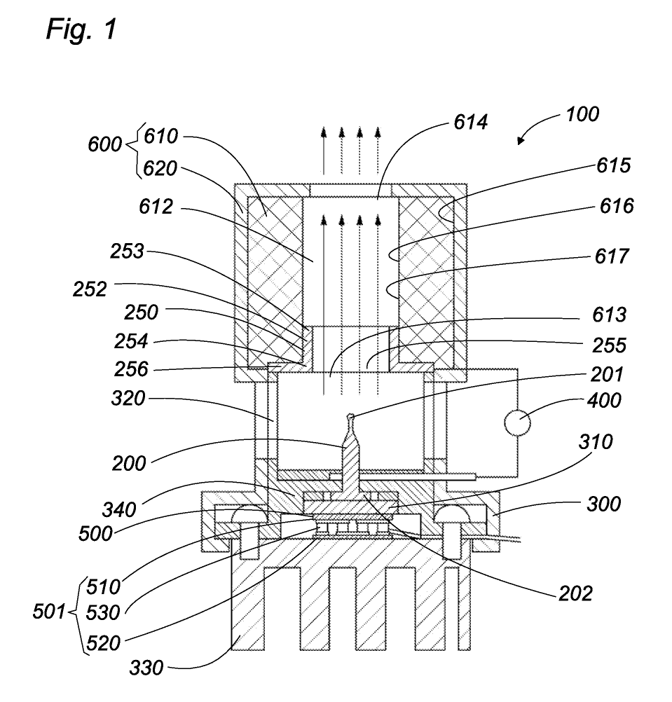

An electrostatically atomizing device in this embodiment is explained with attached illustrations. FIG. 1 shows a side cross sectional view of the electrostatically atomizing device 100. The electrostatically atomizing device 100 comprises an emitter electrode 200, an opposed electrode 250, a carrier 300, a high voltage source 400, a water supply means 500, a fan 540, a silencer 600, and a housing 750.

As shown in FIG. 1, the carrier 300 is formed to have a cylindrical shape. The carrier 300 is provided for holding the emitter electrode 200, the opposed electrode 250, a heat conductive plate 310, the water supply means 500, and a heat radiation fin 330. The carrier 300 has a circumferential wall which is formed with apertures 320. The carrier 300 is formed at lower end with a base 340.

The emitter electrode 200 is made of an electrical conductive material. The emitter electrode 200 is formed to have a rod shape, thereby having an axis. The emitter electrode 200 is formed at its upper end with an emitter end 201. The emitter electrode 200 is formed at its lower end with a flange 202. The flange 202 is thermally coupled to the heat conductive plate 310. The lower end of the emitter electrode 200 is supported by the base 340, whereby the emitter electrode 200 is supported by the carrier 300. Furthermore, the emitter electrode 200 is supported by the base 340 such that the emitter electrode 200 is projected into an inside of the carrier 300. Therefore, the emitter electrode 200 is surrounded by the air. In a case where the emitter electrode 200 is cooled below water dew point, the emitter electrode 200 condenses the vapor in the air around the emitter electrode 200 into water.

The opposed electrode 250 is made of an electrical conductive material. The opposed electrode 250 is formed to have a ring shape, thereby having an opening 255. In particular, the opposed electrode 250 is formed to have a cylinder 252 and a flange 256. The cylinder 252 has one axial end with a first end 253, and the other axial end with a second end 254. The flange 256 is located at the second end 254. The flange 256 is fixed to an upper end of the carrier 300 such that the opposed electrode is disposed in an opposed relation to the emitter electrode 200. Therefore, the second end 254 is fixed to the upper end of the carrier 300. Furthermore, the axis of the emitter electrode 200 is aligned with a center of the opposed electrode 250. The cylinder 252 is located away from the emitter electrode 200 than the flange 256. Therefore, the first end 253 is spaced from the emitter electrode 200 by a distance which is greater than a distance between the second end 254 and the emitter electrode 200. Consequently, the cylinder 252 is projected outwardly of the carrier 300.

The high voltage source 400 is configured to apply voltage of about −4.6 kV between the emitter electrode 200 and the opposed electrode 250. Consequently, when the high voltage source applies the voltage between the emitter electrode 200 and the opposed electrode 250, an electrical field is generated between the emitter electrode 200 and the opposed electrode 250. When the emitter end 201 holds the water, the high voltage source 400 electrostatically atomizes the water by the electrical field. Therefore, the high voltage electrostatically atomizes the water in order to generate mist.

The water supply means 500 is defined by a Peltier module 501. The Peltier module 501 is composed of a first circuit board 510, a second circuit board 520, and a plurality of thermoelectric conversion elements 530. Both the first circuit board 510 and the second circuit board 520 are made of an electrical insulation material. The electrical insulation material is, for example, such as alumina. It is also possible to employ aluminum nitride as the electrical insulation material. Both the first circuit board 510 and the second circuit board 520 are provided at its one surface with patterned circuits which are faced with each other. Each the patterned circuit is connected to a power source (not shown) through wirings. The thermoelectric conversion elements 530 are made of thermoelectric conversion material. The thermoelectric conversion elements 530 are disposed between the first circuit board 510 and the second circuit board 520 such that the thermoelectric conversion elements 530 are arranged in series with each other. Therefore, when the power source applies the voltage between the first circuit board 510 and the second circuit board 520, electrical current is flown through the thermoelectric conversion elements 530.

The thermoelectric conversion elements 530 are configured to transfer heat from the first circuit board 510 to the second circuit board 520 when the electrical current flows through the thermoelectric conversion elements 530. Therefore, when the electrical current flows through the thermoelectric conversion elements 530, the first circuit board 510 is cooled. Therefore, the first circuit board 510 acts as a cooling side of the Peltier module 501. The first circuit board 510 is thermally coupled to the heat conductive plate 310, thereby being thermally coupled to the emitter electrode 200 through the heat conductive plate 310. Therefore, the Peltier module 510 is configured cool the emitter electrode in order to supply water to the emitter electrode 200. In contrast, the second circuit board is heated when the electrical current flows through the thermoelectric conversion elements 530. Therefore, the second circuit board 520 is defined as a heat radiating side of the Peltier module 501. The second circuit board 520 is thermally coupled to the heat radiation fin 330. Therefore, the heat of the second circuit board 520 is transferred to the heat radiation fin 330. The heat of the heat radiation fin 330 is radiated to air around the heat radiation fin 330.

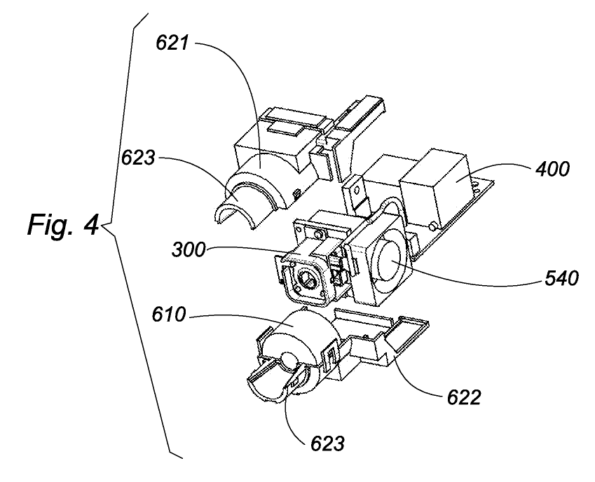

As shown in FIG. 4, the carrier carries the fan 540. The fan is configured to generate airflow. In particular, the fan is configured to generate a first airflow and a second airflow. The first airflow passes through the heat radiation fin 330. That is, the fan 540 is configured to generate the first airflow for cooling the heat radiation fin 330. On the other hand, the second airflow passes through the carrier 300 through the apertures 320. That is, the fan 540 is configured to generate the second airflow for supplying the air which includes vapor to an inside of the carrier 300. The fan 540 is configured to generate airflow which flows around the heat radiation fin 330.

The silencer 600 is provided for absorbing noises. The silencer 600 is composed of a sound absorbing duct 610 and a holder 620. The sound absorbing duct 610 is provided for absorbing the noises. Therefore, it is preferred to employ the sound absorbing duct having a high sound absorption coefficient. Therefore, the sound absorbing duct 610 is required to be made of a material having a high sound absorption coefficient. The material having the high sound absorption coefficient is, for example, such as a foamed resin of urethane series. Furthermore, it is also preferred to employ a sound absorbing duct having an ozone resistance. To apply the ozone resistance to the sound absorbing duct, it is preferred to employ the sound absorbing duct which is made of a material such as a metal wool, foamed resins of EPDM series, and a glass wool. Furthermore, it is also preferred to employ a sound absorbing duct having a water resistant property. To apply the water resistant property, it is also preferred to employ a sound absorbing duct which is made of a material such as the metal wool, a foamed urethane resin of polyether type, and the glass wool. In addition, it is also preferred to employ a sound absorbing duct having a humidity conditioning property. Therefore, it is also preferred to employ the sound absorbing duct which is made of material such as diatomaceous earth.

The sound absorbing duct 610 is formed into a tubular shape such that the sound absorbing duct 610 has an axial bore 612. Therefore, the sound absorbing duct 610 has an outer surface 615 and an inner circumferential surface 616. The axial bore 612 is formed at one axial end with an inlet 613, and is formed at the other axial end with an outlet 614. The inlet 613 has an inner diameter which is approximately equal to an outer diameter of the cylinder 252. Therefore, the mist generated at the emitter end 201 flows to the sound absorbing duct 610. The mist is introduced into the axial bore from the inlet 613, and subsequently is flown through the axial bore 612, and finally is flown out through the axial bore 612 from the outlet 614.

The holder 620 is provided for holding the sound absorbing duct 610. In particular, the holder 620 is shaped to hold the sound absorbing duct 610 such that the holder 620 covers only the outer surface 615 of the sound absorbing duct 610. It is possible to employ adhesion in order to bond the sound absorbing duct 610 to the holder 620. The holder 620 has both axial ends with openings which are communicated with the axial bore 612.

As shown in FIG. 4, the holder 620 is composed of a holder upper half 621 and a holder lower half 622. The holder 620 is shaped to cover the silencer 600, the carrier 300, and the heat radiation fin 330. The holder 620 is provided at its one end with a funnel 623. The funnel 623 is provided for smoothly discharging the mist from the axial bore 612 toward the outside of the silencer 600. Therefore, the holder 620 covers the sound absorbing duct 610 such that the funnel 623 is located in communication with the axial bore 612.

The sound absorbing duct 610 is attached to the opposed electrode 250 such that the cylinder 252 is fitted into the inlet 613. Therefore, inner circumferential surface 616 of the axial bore 612 has a sound absorbing surface 617 which is located between the outlet 614 and the first end 253. The sound absorbing surface 617 extends the entire circumference of the inner circumferential surface. Therefore, the entire circumference of the sound absorbing surface is uncovered. The sound absorbing surface 617 is directly exposed to air in the axial bore 612. Furthermore, the inlet is kept in communication with the opening 255 for directing the mist out of the sound absorbing duct 610 through the outlet 614.

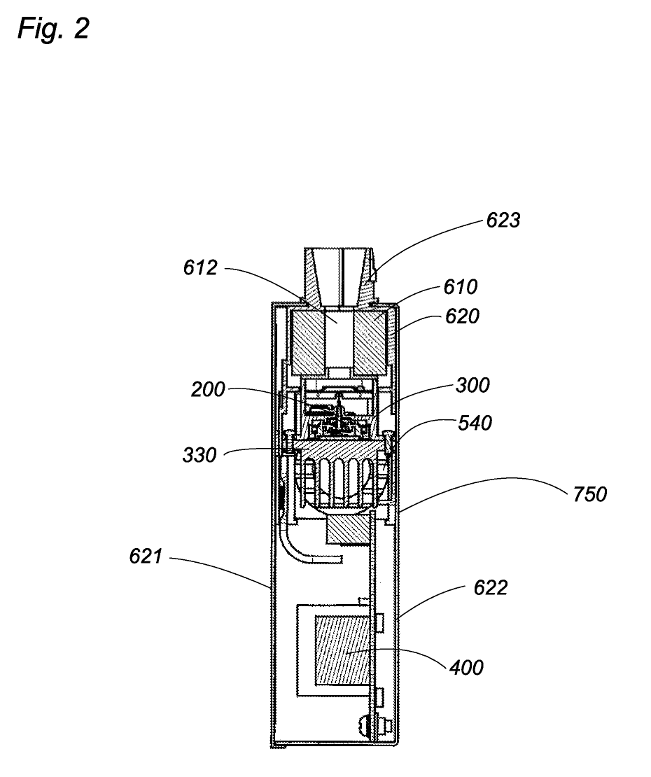

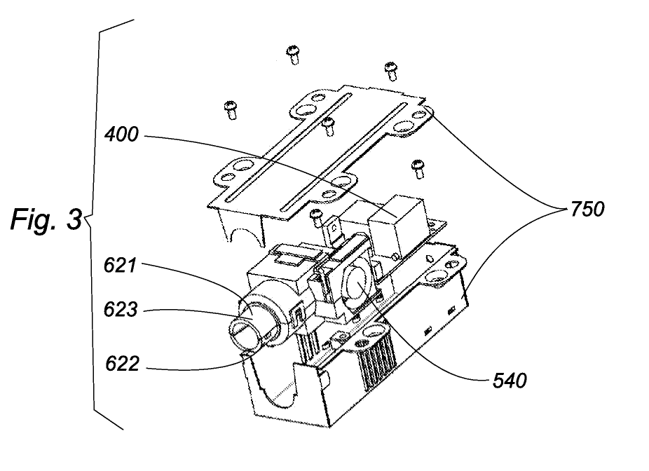

As shown in FIG. 3, the housing 750 incorporates the carrier 300, the high voltage source, the water supply means 500, and the silencer 600. In this manner, the electrostatically atomizing device is constructed. FIG. 2 shows the side cross sectional view of the electrostatically atomizing device. As shown in FIG. 2, the electrostatically atomizing device is incorporated into the housing 750.

The electrostatically atomizing device is operated as follows. First of all, both the high voltage source 400 and the power source are started. When the power source is started, the voltage is applied between the first circuit board 510 and the second circuit board 520. Therefore, the voltage is applied to the thermoelectric conversion elements 530. Consequently, the electrical current flows through the thermoelectric conversion elements 530. According to the electrical current which flows through the thermoelectric conversion elements 530, the thermoelectric conversion elements 530 transfer heat from the first circuit board 510 to the second circuit board 520. As a result, the first circuit board 510 is cooled below the water dew point, and the second circuit board 520 is heated. The first circuit board 510 is thermally coupled to the flange 202 through the heat conductive plate 310. Therefore, when the first circuit board 510 is cooled below the water dew point, the emitter electrode 200 is also cooled below the water dew point. When the emitter electrode 200 is cooled, the emitter electrode 200 cools the air around the emitter electrode 200. Consequently, the emitter electrode 200 having temperature of the water dew point condenses the vapor in the air into the water. Therefore, the water is supplied to a surface of the emitter electrode 200 by the condensation of the vapor in the air. On the other hand, according to transfer of the heat from the first circuit board 510 to the second circuit board 520, the second circuit board 520 is heated. The heat of the second circuit board 520 is transferred to the heat radiation fin 330. The heat of the heat radiation fin 330 is released to the air around the heat radiation fin 330. Furthermore, the fan 540 produces the first airflow which passes through the heat radiation fin 330. Therefore, the fan 540 produces the airflow which cools the heat radiation fin 330. Thus, the heat of the heat radiation fin 330 is released to the air around the heat radiation fin 330.

Furthermore, the high voltage source applies the voltage between the emitter electrode 200 and the opposed electrode 250, the electrical field is generated between the emitter electrode 200 and the opposed electrode 250. The electrical field moves the water on the surface of the emitter electrode toward the emitter end 201. In this manner, the emitter end 201 holds the water. Furthermore, the fan 540 generates the second air flow for passing the air to the inside of the carrier 300 from the outside of the carrier 300. Therefore, the fan 540 is configured to supply the air including the vapor to the inside of the carrier 300 continuously. Consequently, the emitter end 201 continuously holds the water. In addition, the second airflow passes through the sound absorbing duct 610.

Furthermore, because the electrical field is generated between the emitter electrode 200 and the opposed electrode 250, the electrical field electrically charges the water on the emitter end 201. The electrically charged water is pulled toward the opposed electrode by the electrical field. That is, the electrically charged water is pulled toward the opposed electrode by Coulomb force. According to the Coulomb force, the water on the emitter end 201 is formed to have a small cone shape. This cone shaped water is so-called Taylor cone. The small Taylor cone further receives the electrical field. Accordingly, the small Taylor cone is further electrically charged. The further electrically charged water receives large Coulomb force. In this manner, the Taylor cone is enlarged, and has a large amount of electrical charge. Because the Taylor cone has a large amount of the electrical charge, the Taylor cone receives large Coulomb force. Thereafter, the Coulomb force becomes larger than surface tension of the Taylor cone. Then the Taylor cone is broken up. That is, the Rayleigh breakup is caused. According to the Rayleigh breakup, the water on the emitter end 201 is electrostatically atomized. According to the electrostatically atomizing, mist is generated. This mist includes a charged minute water particles.

According to the electrostatically atomizing, an ion wind from the emitter electrode 200 toward the opposed electrode 250 is also generated. The mist wind carries the mist from the carrier 300 to the silencer 600. Furthermore, the second airflow also carries the mist from the carrier 300 to the silencer 600. Therefore, the mist flows toward the silencer 600 through the opening 255 and the inlet 613. Consequently, the mist is flown to the axial bore 612. The outlet flows the mist out through the axial bore. That is, the axial bore 612 directs the mist toward the funnel 623 through the outlet 614. Subsequently, the mist is discharged from the funnel 623.

On the other hand, when the mist is generated according to the electrostatically atomizing, noises are also generated. This noises travels toward the axial bore 612 through the cylinder 252. However, the sound absorbing duct 610 absorbs the noises in the axial bore 612. Furthermore, the entire sound absorbing surface is directly exposed to the air in the axial bore 612. Therefore, the noises in the axial bore 612 are effectively absorbed by the sound absorbing duct 610.

As mentioned above, the electrostatically atomizing device 100 comprises the silencer 600 which is composed of the holder and the sound absorbing duct. The holder 620 holds the sound absorbing duct 610 such that the holder covers only the outer surface 615 of the sound absorbing duct 610. That is, the holder is shaped so as not to cover the inner circumferential surface 616. In addition, the inner circumferential surface 616 has the sound absorbing surface 617. The sound absorbing surface 617 is located between the first end 253 and the outlet 614. The sound absorbing surface 617 extends the entire inner circumferential surface 616. Furthermore, because the holder only covers the outer surface 615 of the sound absorbing duct, the entire sound absorbing surface 617 directly surrounds the air in the axial bore 612. Therefore, the entire sound absorbing surface 617 absorbs the noises generated when the water on the emitter electrode is electrostatically atomized. Consequently, the noises are effectively absorbed by the sound absorbing duct 610.

In addition, the opposed electrode 250 is formed to have a cylinder 252. The cylinder 252 is fitted into the inlet 613. Therefore, it is possible to reduce the dimension of the silencer 600.

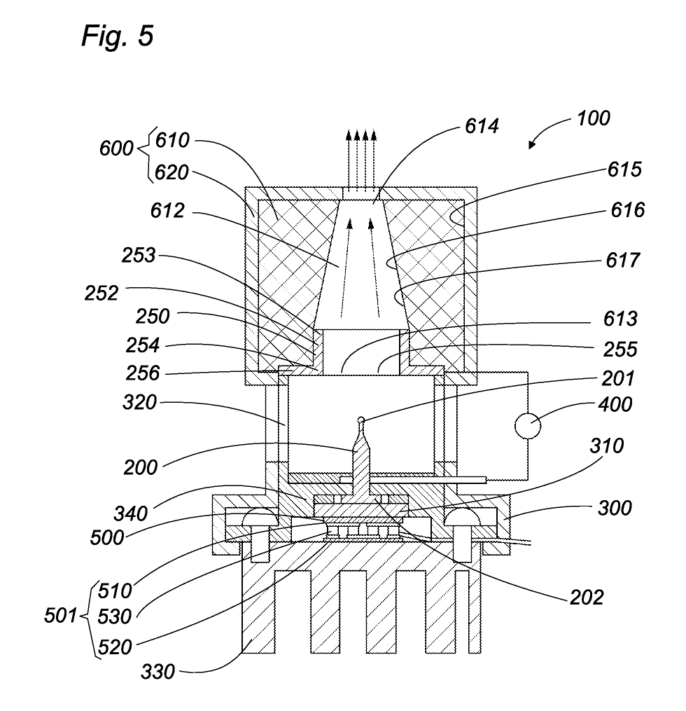

Moreover, it is also possible to employ a sound absorbing duct having an axial bore which has an inside diameter which is gradually becomes smaller from the inlet toward the outlet. FIG. 5 shows the sound absorbing duct 610 having the axial bore 612 which has an inside diameter. The inside diameter of the axial bore 612 gradually becomes smaller from the inlet toward the outlet. Consequently, an inside diameter of the inlet 613 is larger than an inside diameter of the outlet 614. As a result, the axial bore 612 prevents the mist from spreading. Therefore, it is possible to efficiently apply the mist to the target. In addition, this configuration makes it possible to increase volume of the sound absorbing duct 610. As a result, the noises are configured to absorb the noises effectively.

Furthermore, the water supply means is defined by the Peltier module and the power source. The Peltier module is composed of the first circuit board 510, the second circuit board 520, and the thermoelectric conversion elements 530. The thermoelectric conversion elements 530 are disposed between the first circuit board 510 and the second circuit board 520. The power source is configured to apply voltage between the first circuit board 510 and the second circuit board 520 in order to flow the electrical current to the thermoelectric conversion elements 530. The thermoelectric conversion elements 530 are configured to transfer heat from the first circuit board 510 to the second circuit board 520, whereby the thermoelectric conversion elements 530 cools the first circuit board 510. The first circuit board 510 is thermally coupled to the emitter electrode 200 in order to cool the emitter electrode 200, whereby the emitter electrode 200 condenses the vapor in the air around the emitter electrode into water. With this configuration, it is possible to obtain the water supply means which is free from necessity of water supply.

Moreover, in this embodiment, the Peltier module 501 is employed as the water supply means. However, it is also possible to employ the water supply means which is composed of a water tank, a tube, and a pressurizing means such as a piston. In this case, the water tank is configured to store the water. The tube is shaped to connect between the water tank and the emitter electrode. The pressurizing means is configured apply pressure to the water in the water tank in order to send the water to the emitter electrode through the tube. Furthermore, it is also possible to employ the water supply means which is composed of a water tank and a tube which is configured to cause a capillary action. In this case, the water is configured to store the water. The tube is shaped to connect between the water tank and the emitter electrode. The tube is configured to supply water in the water tank to the emitter electrode by the capillary action. Moreover, it is also possible to employ the water supply means which is composed of a water tank having a water outlet. In this case, the water tank is disposed to the housing such that the water in the water tank is dropped to the emitter electrode from the water outlet.

Furthermore, as mentioned above, the sound absorbing duct is made of materials such as the foamed resins of EPDM series, the glass wool and so on. However, it is also possible to combine the materials of the sound absorbing duct. Consequently, it is possible to solve a plurality of the above mentioned problems simultaneously. For example, it is preferred to employ the sound absorbing duct having a first cylindrical layer and a second cylindrical layer surrounding the first cylindrical layer. The first cylindrical layer is made of the foamed resin of EPDM series. The second cylindrical layer is made of the foamed resin of urethane series. With this configuration, the resin of the urethane series is covered by the resin of the EPDM series which has a high ozone resistance. Therefore, it is possible to protect the urethane resin from electrical discharge caused by the electrostatically atomizing. In addition, it is also possible to absorb the noises effectively by the resin of the urethane series. Needless to say, the combination is not limited thereto.

1. An electrostatically atomizing device comprising:
an emitter electrode being formed into a rod shape;
an opposed electrode having an opening, and being disposed in an opposed relation to said emitter electrode;
a water supply means being configured to supply water to said emitter electrode;
a high voltage source being configured to apply voltage between said emitter electrode and said opposed electrode in order to electrostatically atomize the water supplied to said emitter electrode, thereby generating a mist which flows through said opening;
a silencer including a sound absorbing duct being formed into tubular shape to have an axial bore, said axial bore being formed at its one axial end with an inlet in communication with said opening, and being formed at the other axial end with an outlet for flowing said mist out through said axial bore, wherein
said sound absorbing duct is attached to said opposed electrode such that said inlet is kept in communication with said opening for directing said mist out of said sound absorbing duct through said outlet,
said sound absorbing duct having an inner circumferential surface,
said inner circumferential surface including a sound absorbing surface which is located between said opposed electrode and said outlet, and which extends the entire inner circumference of said inner circumferential surface, and
the entire sound absorbing surface being uncovered.

2. The electrostatically atomizing device as set forth in claim 1, wherein
said opposed electrode is shaped to have a cylinder which is fitted into said inlet.

3. The electrostatically atomizing device as set forth in claim 1, wherein
said axial bore has an inside diameter which gradually becomes smaller from said inlet toward said outlet.

4. The electrostatically atomizing device as set forth in claim 1, wherein
said opposed electrode has a first end and a second end,
said sound absorbing surface being located between said first end and said outlet.

5. The electrostatically atomizing device as set forth in claim 2, wherein
said cylinder has a first end and a second end,
said sound absorbing surface being located between said first end and said outlet.

6. The electrostatically atomizing device as set forth in claim 1, wherein
said emitter electrode 200 has an axis which is aligned such that the axis passes through said opening.
